(19) United States
(12) Patent Application Publication
(10) Pub. No.: US 2026/0315305 A1
(43) Pub. Date: Oct. 15, 2026

(54) EXOSKELETON AND METHOD

(71) Applicant: exolQ GmbH, Hamburg (JP)

(72) Inventors: Johannes LÜGGER, Hamburg (DE); Bernward OTTEN, Hamburg (DE)

(21) Appl. No.: 19/467,421

(22) Filed: Feb. 2, 2026

(30) Foreign Application Priority Data
Feb. 3, 2025 (EP) 25155510.8

(51) Int. Cl. A61H 3/00; B25J 9/00

(52) U.S. Cl. CPC A61H 3/008; B25J 9/0006; A61H 2003/007; A61H 2201/1215

(57) ABSTRACT

An exoskeleton that includes a first support section for supporting a first body part and a second support section for supporting the exoskeleton against a second body part, and a drive device for providing a relative support pivoting movement between the first support section and the second support section. The exoskeleton has a support mode and a freewheeling mode and the drive device is designed, in the support mode, to provide a drive torque and to convert the drive torque into the relative support pivoting movement by means of a mechanical rotational movement coupling between a drive element and an output element, and in the freewheeling mode to suspend the mechanical rotational movement coupling between the drive element and the output element with respect to a freewheeling angular range.

### CROSS REFERENCE TO RELATED APPLICATION

This application claims priority to European Patent Application No. 25155510.8 filed Feb. 3, 2025, which is incorporated by reference.

### BACKGROUND

The invention relates to an exoskeleton, in particular a back exoskeleton for supporting a lifting movement performed with the upper body, comprising a first support section for supporting a first body part, in particular the upper body, and a second support section for supporting the exoskeleton against a second body part, in particular a leg, as well as a drive device for providing a relative support pivoting movement between the first support section and the second support section, wherein the exoskeleton has a support mode and the drive device is designed, in the support mode, to provide a drive torque and to convert the drive torque into the relative support pivoting movement by means of a mechanical rotational movement coupling between a drive element and an output element.

From U.S. Pat. No. 11,759,345 B2, a wearable assistance device for supporting forward-leaning movements of the upper body is known.

### SUMMARY

An object is to facilitate the use of the exoskeleton.

The object is achieved by an exoskeleton according to claim 1. The exoskeleton further possesses a freewheeling mode, wherein the drive device is designed, in the freewheeling mode, to suspend the mechanical rotational movement coupling between the drive element and the output element with respect to a freewheeling angular range, such that within the freewheeling angular range a relative pivoting movement between the first support section and the second support section effected by means of a user force is enabled without the drive element thereby being set into a rotational movement by the output element.

In this way, the user is enabled to move, in particular to walk, with the exoskeleton donned such that the relative pivoting movement between the first support section and the second support section occurs without thereby having to overcome a resistance or a force with his user force, which resistance or force would result in the case of an established mechanical rotational movement coupling between the drive element and the output element from the fact that, due to this rotational movement coupling, the drive element (and thereby, for example, a rotor of an electric motor) is set into rotational movement by the relative pivoting movement.

This rotational movement (which can be avoided in the freewheeling mode) is in particular a rotational movement of the drive element about its own axis of rotation, in particular relative to a stator of the electric motor.

Consequently, in the freewheeling mode, the user is less hindered by the exoskeleton when performing certain movements, in particular when walking, so that the use of the exoskeleton can be facilitated. By the term “user force,” a force exerted by the user himself (for example with a leg) is meant. By the term “user,” a user who has donned the exoskeleton is meant.

Advantageous further developments are the subject matter of the dependent claims.

The invention further relates to a method for operating the exoskeleton. The method comprises the steps: operating the exoskeleton in the support mode, in which the drive device provides the drive torque and converts it into the relative support pivoting movement by means of the mechanical rotational movement coupling between the drive element and the output element; putting the exoskeleton into the freewheeling mode; and operating the exoskeleton in the freewheeling mode, in which the mechanical rotational movement coupling between the drive element and the output element is suspended with respect to the freewheeling angular range, wherein within the freewheeling angular range the relative pivoting movement between the first support section and the second support section effected by means of the user force is performed without the drive element thereby being set into a rotational movement by the output element.

### BRIEF DESCRIPTION OF THE DRAWINGS

Further exemplary details as well as exemplary embodiments are explained below with reference to the figures. Therein shows:

FIG. 1 an exoskeleton worn by a user in a side view,

FIG. 2 the exoskeleton worn by the user in a view from behind,

FIG. 3 a bending angle between a first support section and a second support section of the exoskeleton,

FIG. 4 a movement angular range between two angular positions of the second support section,

FIG. 5 a schematic representation of a transmission of the exoskeleton according to a first embodiment,

FIG. 6 a perspective view of the transmission according to the first embodiment,

FIG. 7 an output element of the transmission according to the first embodiment,

FIG. 8 a drive element of the transmission according to the first embodiment,

FIG. 9 a perspective view of the transmission according to the first embodiment,

FIG. 10 a schematic representation of the transmission according to a second embodiment,

FIG. 11 a further schematic representation of the transmission according to the second embodiment,

FIG. 12 a perspective representation of the transmission according to the second embodiment in an opened drive unit housing,

FIG. 13 a further perspective representation of the transmission according to the second embodiment, wherein a spiral spring is shown,

FIG. 14 a further perspective representation of the transmission,

FIG. 15 a perspective representation of the transmission with a brake device,

FIG. 16 a perspective representation of the transmission with a movement sensor.

### DETAILED DESCRIPTION

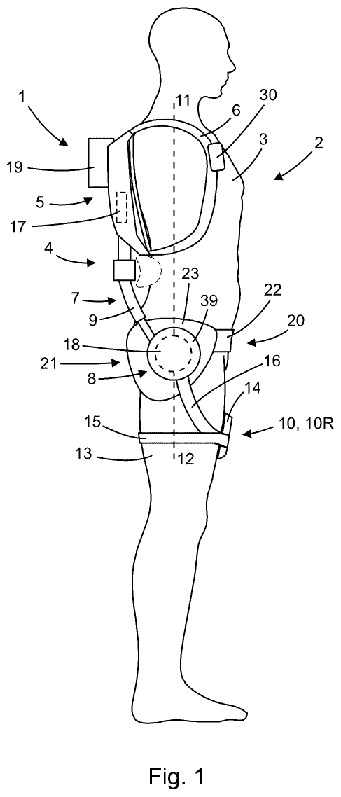

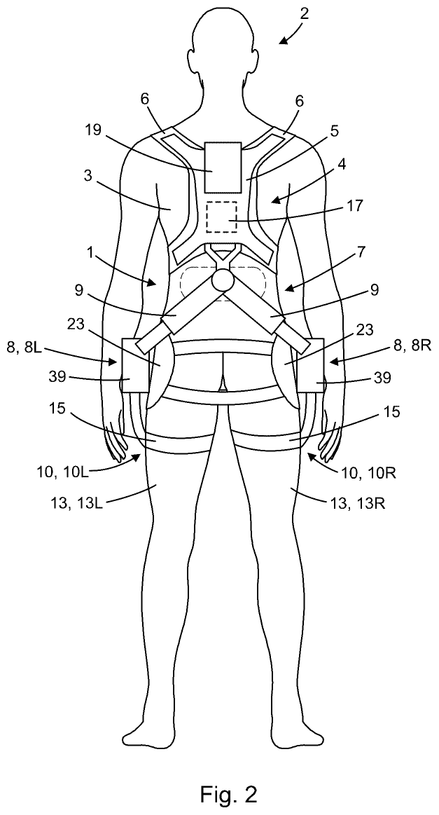

FIGS. 1 and 2 show an exemplary design of an exoskeleton 1 which is worn by a user 2. By the formulation that the user 2 wears the exoskeleton 1, it is meant that the user 2 has donned the exoskeleton 1 as intended. The exoskeleton 1 is designed exemplarily as a back exoskeleton.

The exoskeleton 1 serves to support a lifting movement performed with the upper body 3 (of the user 2). For example, during the lifting movement, the user 2 straightens his upper body 3 from a forward-inclined position towards an upright position. Typically, during the lifting movement, the user 2 holds an object, in particular a heavy object, with his hands and/or arms. The object shall be moved upwards by the lifting movement.

The exoskeleton 1 comprises a first support section 4 for supporting a first body part. The first body part is exemplarily the upper body 3. The first support section 4 is designed in particular for fastening to the first body part. Exemplarily, the first support section 4 comprises a back section 5 which serves to be worn on the back of the user 2. Expediently, the first support section 4 comprises one or two shoulder straps 6 for fastening the back section 5 to the upper body 3. Exemplarily, each shoulder strap 6 runs from an upper region of the back section 5 to a lower region of the back section 5.

The first support section 4 is mechanically coupled to one or two drive units 8. Exemplarily, the exoskeleton 1 has two drive units 8; according to an alternative design, the exoskeleton can also have only one drive unit 8. The present explanations are intended to apply both to the case with two drive units 8 and (correspondingly) to the case with one drive unit 8. Exemplarily, the first support section 4 comprises a first coupling section 7, via which the back section 5 is mechanically coupled to the one or two drive units 8. Exemplarily, the first coupling section 7 has two in particular elongated coupling elements, which, starting from a horizontally central position, exemplarily below the back section 5, extend away from one another diagonally downwards and laterally outwards towards the drive units 8. This is shown in FIG. 2. The coupling elements 9 are optionally adjustable in their length. The first coupling section 7, in particular each coupling element 9, is expediently fastened in a rotationally fixed manner to a respective drive unit 8, in particular a respective drive unit housing 39.

The orientation of the first support section 4 shall be described by means of a first support section axis 11. The first support section axis 11 corresponds in particular to the orientation of the upper body 3 to which the first support section 4 is fastened. In an upright position of the upper body 3, the first support section axis 10 is vertically aligned, as exemplarily shown in FIG. 1.

The exoskeleton 1 comprises at least one second support section 10 for supporting the exoskeleton 1 against a second body part. The second support section 10 is designed in particular for fastening to the second body part. The second body part is, for example, a leg 13 of the user. Preferably, the exoskeleton 1 comprises two second support sections 10, in particular a respective second support section 10 for each leg 13 of the user. The present explanations are intended to apply both to the case with two second support sections 10 and (correspondingly) to the case with only one second support section 10. Each second support section 10 is designed for fastening to a respective leg 13, in particular to a respective thigh, of the user 2. The second support sections 10 comprise exemplarily a left (second) support section 10L for the left leg 13L and a right (second) support section 10R for the right leg 13R. The terms “left” and “right” refer to the perspective of the user 2.

The second support sections 10 are expediently formed corresponding to one another, in particular mirror-symmetrically to one another. Exemplarily, each second support section 10 possesses a (in particular padded) respective leg rest 14, which (in a worn state of the exoskeleton 1) rests expediently on the front of the respective leg 13, in particular the respective thigh. Exemplarily, each second support section 10 further possesses a respective leg strap 15, which, starting in particular from the respective leg rest 14, runs around the respective leg 13 (in the worn state of the exoskeleton 1).

Each second support section 10 is mechanically coupled to a respective drive unit 8.

Exemplarily, each second support section 10 comprises a respective second coupling section 16, via which the respective leg rest 14 is mechanically coupled to a respective drive unit 8, in particular is fastened in a rotationally fixed manner to a respective output element 25 or second output element 32.

The orientation of each second support section 10 shall be described by means of a respective second support section axis 12. Each second support section axis 12 corresponds in particular to the orientation of the leg 13, in particular the thigh, to which the respective second support section 10 is fastened. In an upright position of a leg 13, the respective second support section axis 12 is vertically aligned, as exemplarily shown in FIG. 1.

The exoskeleton 1 expediently comprises a hip section 20 which serves to be fastened in the region of the hip 21 of the user 2. The hip section 20 comprises exemplarily a hip belt 22 which (in a worn state of the exoskeleton 1) encloses the hip (and/or the waist) of the user. Exemplarily, the hip section 20 possesses two lateral hip elements 23, which (in the worn state) are arranged in particular in the region on the outside of the hip joints of the user. Exemplarily, a respective drive unit 8 is arranged on each hip element 23.

The exoskeleton 1 comprises a drive device. The drive device comprises exemplarily the drive units 8 (or only one drive unit 8, provided only one drive unit 8 is present). The drive units 8 comprise exemplarily a left drive unit 8L and a right drive unit 8R. Each drive unit 8 possesses a respective electric motor 18. The drive device further comprises a control unit 17 for controlling each electric motor 18. The control unit 17 is designed in particular as a microcontroller. The control unit 17 can be arranged, for example, in the first support section 4, in particular the back section 5. Alternatively, the control unit 17 can be arranged in a drive unit 8 (or be distributed over both drive units 8). The drive device expediently comprises a rechargeable battery 19 for the energy supply of the exoskeleton 1, in particular of the control unit 17 and/or each electric motor 18. The battery 19 can be arranged, for example, on the back section 5 or be part of the back section 5. Expediently, each operation of each electric motor 18 explained below takes place according to a corresponding control by the control unit 17.

In the worn state of the exoskeleton 1, the left drive unit 8L is arranged in the left hip region of the user and the right drive unit 8R in the right hip region of the user. Each drive unit 8 expediently possesses a respective drive unit housing 39, in which in particular the respective electric motor 18 is arranged. Furthermore, each drive unit 8 possesses a respective drive element 24 and a respective output element 25, which are arranged in particular in the respective drive unit housing 39 and for example form part of a respective transmission.

The drive device serves to provide a relative support pivoting movement between the first support section 4 and each second support section 10. Exemplarily, the drive device serves (by means of the left drive unit 8L) to provide a first relative support pivoting movement between the first support section 4 and the left second support section 10 and (by means of the right drive unit 8R) to provide a second relative support pivoting movement between the first support section 4 and the right second support section 10. By the term “relative support pivoting movement,” the first relative pivoting movement and/or the second relative pivoting movement is meant in particular.

The exoskeleton 1 has a support mode. The drive device is designed, in the support mode, to provide a drive torque and to convert the drive torque into the relative support pivoting movement by means of a mechanical rotational movement coupling between a drive element 24 and an output element 25. The drive element 24 and the output element 25 will be explained in more detail below. The drive element 24 and the output element 25 are expediently part of the drive device, for example part of a transmission of the drive device. The drive torque is expediently provided by means of a respective electric motor 18. By the formulation “mechanical rotational movement coupling between a drive element 24 and an output element 25,” it is meant that a rotational movement of the drive element 24 is mechanically converted into a rotational movement of the output element 25, and conversely a rotational movement of the output element 25 is mechanically converted into a rotational movement of the drive element 24.

In the present exemplary design with two drive units 8, in the support mode each electric motor 18 provides a respective drive torque, which is converted in the respective drive unit 8 via the respective mechanical rotational movement coupling between the respective drive element 24 and the respective output element 25 into the respective relative support pivoting movement.

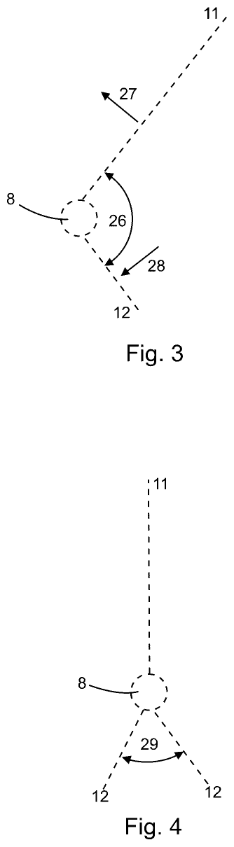

The two drive units 8L, 8R are designed corresponding to one another, in particular functionally identically. Optionally, the two drive units 8L, 8R are designed structurally mirror-symmetrically to one another. Explanations referring to one drive unit 8 (or its components) expediently apply respectively to each of the two drive units 8L and 8R (or to their components). Likewise, explanations referring to a second support section 10 shall expediently apply respectively to each of the two second support sections 10L and 10R. The support mode shall be explained in more detail with reference to FIG. 3. The support section axes 11, 12 are shown here in the side view (as in FIG. 1). The user 2 has bent his upper body 3 forward; accordingly, the first support section axis 11 is inclined forward; thus it runs in a vertical plane diagonally forward and upward, starting from the drive unit 8. Exemplarily, the user 3 further assumes a squat, so that the second support section axes 12 (corresponding to the orientation of the thighs) are inclined forward, and accordingly run in the vertical plane diagonally forward and downward, starting from the drive unit 8. This position of the exoskeleton 1 or user 2 shall be referred to as the bent position. The angle between the first support section axis 11 and the second support section axes 12 shall be referred to as the bending angle 26. The bending angle 26 is less than 180 degrees and preferably greater than 50 degrees. For example, the bending angle 26 in the bent position amounts to between 70 and 120 degrees. In the present design with two second support sections 10, there is a separate bending angle (relative to the first support section 4) for each second support section 10. The present explanations referring to the bending angle 26 shall expediently apply to both bending angles. The two second support section axes 12 can have the same or mutually different orientations; in the latter case, the bending angles differ from one another.

In the support mode, each electric motor 18 is active and provides a respective drive torque. For example, a respective stator of each electric motor 18 is coupled in a rotationally fixed manner to the first support section 4, for example via the respective drive unit housing 39. The respective rotor of each electric motor 18 drives the respective drive element 24 according to the drive torque. Optionally, the drive element 24 can be the rotor or part of the rotor. The respective drive element 24 drives (via the mechanical rotational movement coupling) the respective output element 25. Via the rotational movement of the respective output element 25, the respective second support section 10 is pivoted relative to the first support section 4, whereby the respective relative support pivoting movement is effected.

Each second support section 10 supports itself on the respective thigh, so that the respective relative support pivoting movement leads to the first support section 4 (with its first support section axis 11) being pivoted in the direction towards an upright (in particular vertical) alignment. The bending angle 26 increases.

The respective drive torque provided by each electric motor 18 is converted into a support force, in particular a tensile force 27, which acts on the upper body 3 via the first support section 4; the second support sections 10 transmit a counterforce 28 corresponding to this support force into the thighs of the user. By the support force provided by the exoskeleton 1, the upper body 3 of the user is supported during a lifting movement and thus in particular the back of the user is relieved.

Optionally, the exoskeleton 1 can serve in the support mode to support the user in a static bent position with the support force (without a support pivoting movement being performed).

In the present example, two drive units 8, thus in particular two electric motors 18, or two (separate) second support sections 10 are present. As already mentioned above, according to an alternative design, the exoskeleton 1 can also be designed with only one drive unit 8, in particular only one electric motor 18, and/or only one second support section 10. In this case, the present explanations apply correspondingly to the one drive unit 8, in particular the one electric motor 18, and/or the one second support section 10.

The exoskeleton 1 further has a freewheeling mode. The drive device is designed, in the freewheeling mode, to suspend the mechanical rotational movement coupling between the drive element 24 and the output element 25 with respect to a freewheeling angular range, so that within the freewheeling angular range a relative pivoting movement between the first support section 4 and the second support section 10 effected by means of a user force is enabled without the drive element 24 thereby being set into a rotational movement by the output element 25. The mechanical rotational movement coupling is suspended in the freewheeling mode for the entire freewheeling angular range. The freewheeling angular range amounts, for example, to at least 20 degrees and/or at most 40 degrees or 50 degrees. In the freewheeling mode, expediently, in the respective drive unit 8, the respective mechanical rotational movement coupling between the respective drive element 24 and the respective output element 25 is suspended with respect to a respective freewheeling angular range, so that within the respective freewheeling angular range a respective relative pivoting movement between the first support section 4 and the respective second support section 10 effected by means of a user force is enabled without the respective drive element 24 thereby being set into a rotational movement by the respective output element 25. The respective relative pivoting movement effected by the user force is caused in particular by walking of the user. The respective user force is applied to the respective second support section 10 by the respective leg.

In the freewheeling mode, no drive torque is provided by the electric motor 18, or no drive torque originating from the electric motor 18 is transmitted from the drive element 24 to the output element 25. For example, in the freewheeling mode, the electric motor 18, in particular both electric motors 18, is/are switched off. Alternatively, in the freewheeling mode, each electric motor 18 can be controlled such that the respective drive element 24 moves according to the respective output element 25 in order to prevent a force or torque transmission from the output element 25 to the drive element 24 and/or to prevent the mechanical rotational movement coupling from being established.

Upon a change from the support mode into the freewheeling mode, the drive torque provided by the electric motor 18 can be gradually reduced, in particular down to zero. Upon a change from the freewheeling mode into the support mode, the drive torque can be gradually increased, in particular starting from zero. In particular, a closed-loop control of the torque can take place, for example indirectly via a current closed-loop control. In this way, a smooth start-up can be ensured.

The freewheeling mode shall be explained in more detail with reference to FIG. 4. The support section axes 11, 12 are shown here in the side view (as in FIG. 3). The explanations refer to one second support section 10 or one drive unit 8, but shall expediently apply correspondingly to each of the two support sections 10 or to each of the two drive units 8, provided two support sections 10 or two drive units 8 are present.

In the freewheeling mode, the second support section 10 is intended to be moved within a movement angular range 29 by means of the user force. The first support section 4 is therein not moved or moved less or differently than the second support section 10, so that a relative pivoting movement takes place between the first support section 4 and the second support section 10.

For example, the user 2 walks one or more steps with the exoskeleton donned. The upper body 3 of the user 2 remains therein essentially in an upright posture (as shown in FIG. 4 by means of the first support section axis 11), while the second support section 10 passes through the movement angular range 29 with each step. The second support section 10 is therein moved by a user force—exemplarily by a force provided by the thigh. The movement angular range 29 amounts, for example, to between 20 and 40 degrees. According to a possible design, the freewheeling angular range is equal to the movement angular range 29. Due to the fact that in the freewheeling mode the mechanical rotational movement coupling between the drive element 24 and the output element 25 is suspended with respect to the freewheeling angular range, the user can perform this movement passing through the movement angular range 29—exemplarily the one or more steps—without the drive element 24 (and thereby for example the rotor of the electric motor 18) thereby being set into rotational movement by the output element 25. Thus, in the freewheeling mode, the movement performed with the second support section 10 is performable more easily—i.e., with less expenditure of force—for the user, since the user does not have to set the drive element 24 or the rotor of the electric motor 18 into a rotational movement.

As already mentioned, the exoskeleton 1 is in particular a back exoskeleton, the first support section 4 serves to support the upper body 3 and the second support section 10 serves for support against a leg 13. The freewheeling angular range is designed such that the user 2 of the back exoskeleton can perform a complete step cycle with at least one leg 13 in the freewheeling mode without the drive element 24 being set into a rotational movement by the output element 25 due to a relative pivoting movement between the first support section 4 and the second support section 10 effected by the step cycle. A complete step cycle shall in particular be designated as the movement of the thigh (or of the second support section axis 12) passing through the movement angular range 29, for example starting from a position of the thigh maximally inclined forward during the movement to a position of the thigh maximally inclined backward back to the position of the thigh maximally inclined forward. Preferably, the output element 25 is placeable into a freewheeling position in order to thereby suspend the rotational movement coupling with respect to the freewheeling angular range (and thus put the exoskeleton 1 into the freewheeling mode). The output element 25 is expediently placeable into the freewheeling position by a relative pivoting movement between the first support section 4 and the second support section 10 effected by means of a user force. According to a possible design, the exoskeleton 1 is designed to detect whether an application situation associated with the support mode or the freewheeling mode is present and to control the provision of the drive torque on the basis of this detection. For example, the exoskeleton 1 detects, by means of a corresponding sensor system, for example one or more acceleration sensors and/or one or more rotation rate sensors, one or more absolute and/or relative orientations of the first support section 4 and/or one or both second support sections 10, and/or one or more movements and/or movement patterns of the first support section 4 and/or one or both second support sections 10.

For example, in response to the first support section axis 11 and the second support section axis 12 being inclined forward as shown in FIG. 3 and the two second support sections 10 being essentially stationary and/or having essentially the same orientation, the exoskeleton 1 detects that an application situation associated with the support mode is present and, in response thereto, provides the drive torque by means of one or both electric motors 18. Furthermore, in response to the second support section axis 12 being aligned essentially vertically, the exoskeleton 1 can detect that an application situation associated with the freewheeling mode is present, and in response thereto deactivate the provision of the drive torque.

Optionally, the user can manually set whether the drive torque is provided, for example by means of an operating device 30 of the exoskeleton 1, which can be arranged for example on a shoulder strap 6.

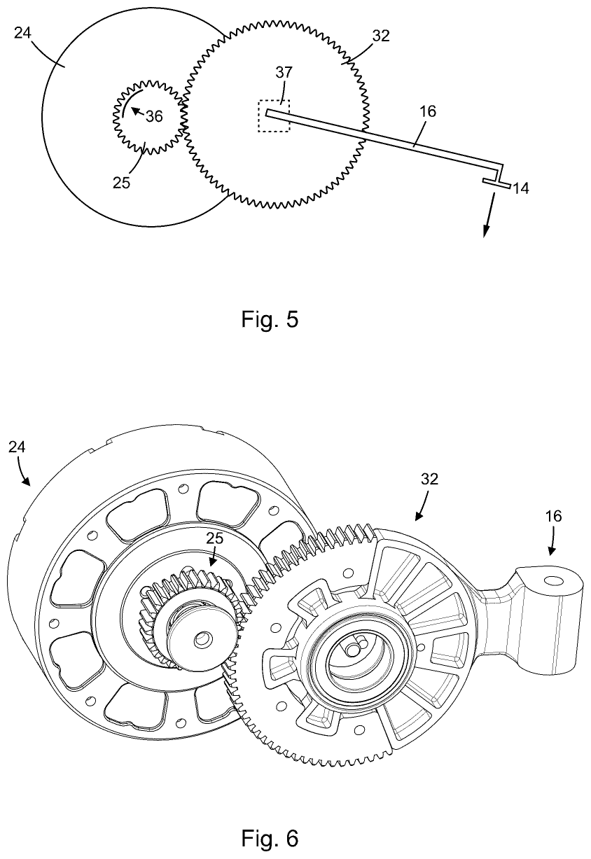

In the following, with reference to FIGS. 5 to 9, an exemplary first embodiment shall be discussed, in which the first support section 4 and the second support section 10 are coupled to one another in particular via a gear transmission. The following explanations expediently apply to each of the two drive units 8 or each of the two support sections 10.

The drive element 24 is exemplarily part of the rotor of the electric motor 18 (or represents the rotor of the electric motor 18) or is coupled in a rotationally fixed manner to the rotor of the electric motor 18. As shown in FIGS. 6, 8 and 9, the drive element 24 exemplarily has a circular-cylindrical basic shape. The output element 25 is a first output element and is exemplarily designed as a first gear wheel. The first output element 25 is expediently arranged coaxially to the drive element 24. The drive device, in particular the drive unit 8, further comprises a second output element 32, which is exemplarily designed as a second gear wheel, and is arranged in particular in the drive unit housing 39. In particular, each drive unit 8 comprises a respective second output element 32. The second output element 32 is arranged directly next to the first output element 25, wherein the axes of rotation of the first output element 25 and of the second output element 32 are aligned parallel to one another.

FIG. 5 shows schematically the interaction between the drive element 24, the output element 25 (which shall also be referred to here as the first output element), the second output element 32, the second coupling section 16 and the leg rest 14. The drive element 24 drives the first output element 25 rotationally. The first output element 25 and the second output element 32 are in engagement with one another and exemplarily form a gear transmission. In particular, the toothing present on the circumference of the first output element 25 engages into the toothing present on the circumference of the second output element 32. The second coupling section 16 is fastened in a rotationally fixed manner to the second output element 32. The leg rest 14 is fastened to the second coupling section 16.

Preferably, the first output element 25 and the second output element 32 form a reduction gear. The second output element 32 preferably has a larger diameter than the first output element 25.

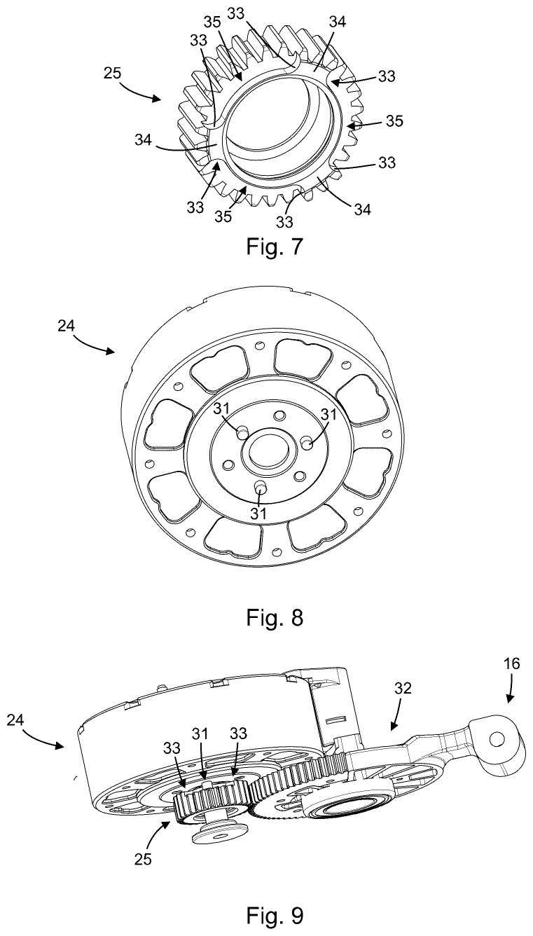

Exemplarily, the drive element 24 and the output element 25 together form a mechanical clutch which comprises at least one engagement section 31 and at least two end stops 33. The engagement section 31 is shown e.g. in FIG. 8 and the end stops 33 in FIG. 7. Exemplarily, the engagement section 31 is part of the drive element 24. In particular, the engagement section 31 is a protrusion, in particular a cylindrical one, for example a pin, arranged on an end face of the drive element 24. The end face shall be designated as that surface which is aligned perpendicular to the axis of rotation of the drive element 24. Exemplarily, the drive element 24 has several, in particular three, engagement sections 31, which are arranged in particular on an imaginary circular path. The imaginary circular path runs concentrically to the axis of rotation of the drive element 24.

The end stops 33 are exemplarily part of the output element 25. Expediently, the end stops 33 are formed by two elevations 34 arranged on the end face of the output element 25. The end face is aligned perpendicular to the axis of rotation of the output element 25. The elevations 34 rise in the axial direction of the axis of rotation. Exemplarily, three elevations 34 are present, which are arranged in particular on an imaginary circular path which runs concentrically to the axis of rotation of the output element 25. Each elevation 34 provides two end stops 33.

According to an alternative design, the engagement sections 31 are part of the output element 25 and the end stops 33 are part of the drive element 24.

Between two (adjacent) end stops 33 (which are provided in particular by different elevations 34), a respective circular arc path 36 is defined, along which the engagement section 31 is movable relative to the end stops 33. Exemplarily, an engagement section pocket 35 is present in the circumferential direction between two adjacent elevations 34, in which pocket a respective engagement section 31 is located (as can be seen e.g. in FIG. 9), which can move from one end stop 33 to an adjacent end stop 33 during a relative rotational movement between the drive element 24 and the output element 25.

The engagement section pockets 35 are expediently arc-shaped. Each engagement section pocket 35 defines a respective circular arc path 36 and thus the freewheeling angular range. The sum of the arc angles of all engagement section pockets 35 is smaller than 360°. Expediently, each engagement section 31 is arranged in a respective engagement section pocket 35 and can move there between the respective two adjacent elevations 34 on a respective circular arc path 36.

The following explanations directed to one engagement section 31 apply expediently to all engagement sections 31 (provided several engagement sections 31 are present).

The clutch (composed of the drive element 24 and the first output element 25) is placeable into a transmission state, in which the engagement section 31 is in engagement with the one or the other of the two end stops 33, in order to provide the rotational movement coupling. In the support mode, the transmission state is given. The drive device is designed, in the support mode, to provide the support pivoting movement by the drive torque being transmitted by means of the mechanical clutch from the drive element 24 to the first output element 25 and being converted into the support pivoting movement by the engagement of the first output element with the second output element.

The clutch is further placeable into a freewheeling state, in which the engagement section 31 is spaced apart from both end stops 33 (assigned to this engagement section 31) and is movable along the circular arc path 36, in order to suspend the mechanical rotational movement coupling between the drive element 24 and the output element 25 with respect to the freewheeling angular range. The two end stops which limit the circular arc path 36 of the engagement section 31 shall be designated as assigned end stops 33. The freewheeling state is shown for example in FIG. 9. The freewheeling angular range is defined by the length of the circular arc path 36. In particular, the freewheeling angular range corresponds to that angular range over which the circular arc path 36 extends. Within this freewheeling angular range, the first output element 25 can be moved rotationally (by a corresponding movement of the second support section 10, which is transmitted via the second output element 32 to the first output element 25), without the drive element 24 being set into a rotational movement by the first output element 25.

The user can put the clutch into a freewheeling state in particular by performing one or two relative pivoting movements between the first support section 4 and the second support section 10 by means of his user force, for example first in one direction and then in the opposite direction. In the example of FIG. 4, the user 2 can put the clutch into the freewheeling state by the user 2 moving his corresponding leg 13 backwards, so that the second support section 10 fastened thereto assumes, with its second support section axis 12, the position maximally inclined backwards within the movement angular range 29, and thereafter moves the leg (for example by half the freewheeling angular range) forwards.

For example, the second support section 10 and the second output element 32 fixedly connected thereto are moved by a walking movement of the user, so that a rotational movement of the first output element 25 occurs. The engagement section pockets 35 rotate relative to the engagement sections 31 such that the end stops 33 do not touch the engagement sections 31 of the drive element 24. The user of the exoskeleton feels no resistance when executing the walking movement.

If, during a walking movement of the user, an engagement of the end stops 33 with the engagement sections 31 exists, a rotational movement of the drive element 24 is thereby effected. The user feels a resistance once. Upon repeated, identical actuation of the second support section 10, the user feels no further resistance, since the rotation of the first output element 25 now takes place expediently exclusively in the angular range of the engagement section pockets 35 or in the freewheeling angular range.

According to a possible design, the freewheeling state can be assumed independently by the exoskeleton 1, by the electric motor 18 rotating the drive element 24 such that the engagement section 31 abuts no end stop 33, i.e., is spaced apart from the respectively assigned end stops 33.

Exemplarily, the second gear wheel has a toothing only along a circular arc—thus only a part of its circumference—so that the conversion of the drive torque into the support pivoting movement takes place only within the angular range of this circular arc. This is shown e.g. in FIG. 6, where the teeth of the second output element 32 extend only over somewhat more than half the circumference of the second output element 32—exemplarily over an angular range of at least 180 degrees and/or at most 230 degrees. The angular range can correspond, for example, to the typical range of motion of the human leg in the work activities to be supported. In this way, weight and installation space can be saved. In addition, the range of motion of the exoskeleton 1 can thus be limited to the range of motion of the human joints to increase safety. This can prevent hyperextension of limbs in the event of a malfunction. Preferably, the exoskeleton 1 possesses a sensor device 37, for example a rotation angle sensor, for detecting a rotational movement of the second output element 32. The drive device is preferably designed, in the freewheeling mode, to drive the drive element 24 (by means of the electric motor 18) on the basis of the detected rotational movement, such that the engagement section 31 is kept at a distance from the end stops 33. In this way, a movement angular range 29 can be achieved which is larger than the freewheeling angular range. The detection of the rotational movement and control of the electric motor 18 is performed by the control unit 17. In particular, by a walking of the user, a periodic rotational movement of the first output element 25 is generated, in which the first output element 25 rotates alternately in a first direction and in a direction opposite to the first direction. The control unit 17 detects this rotational movement of the first output element 25 via the sensor device 37 and controls the electric motor 18 such that it sets the drive element 24 into a corresponding periodic rotational movement, so that the engagement section 31 is kept at a distance from the assigned end stops 33. In particular, the control of the electric motor 18 takes place such that the engagement sections 31 are kept constantly in the angle bisector or the middle of the arc angle of the circular arc paths 36 or the engagement section pockets 35.

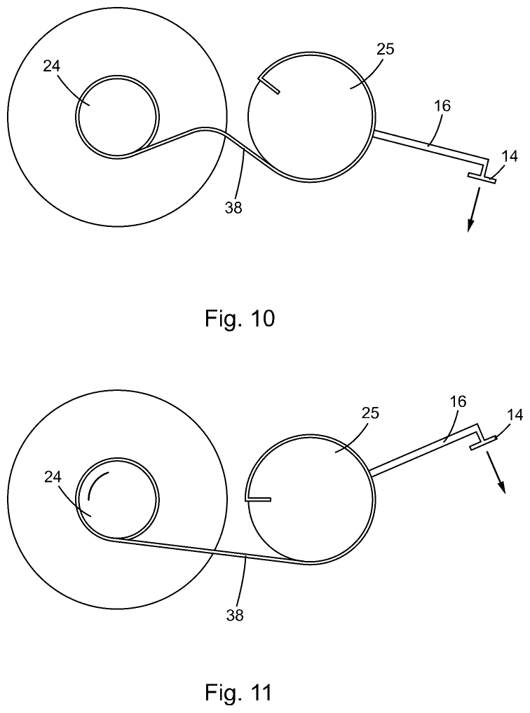

In the following, with reference to FIGS. 10 to 16, an exemplary second embodiment of the drive unit 8 shall be discussed, in which the first support section 4 and the second support section 10 are coupled to one another in particular via a cable pull transmission. The following explanations expediently apply to each of the two drive units 8 or each of the two support sections 10.

In the second embodiment, the drive device, in particular the drive unit 8, possesses a flexible (e.g. form-soft) connecting element 38, in particular a rope, tape, cord or filament. For example, the connecting element 38 is a textile rope (e.g. made of a synthetic chemical fiber based on polyethylene with in particular ultra-high molecular mass, for example Dyneema), a steel rope, or steel tape, a plastic cord or monofilament (e.g. fishing line). The drive element 24 comprises a drive pulley and the output element 25 comprises an output pulley. By the term “flexible” (or “form-soft”) connecting element 38, a connecting element is meant in particular which is not stable in its form and/or changes its form already by gravity, thus for example does not remain on its own in a vertically upward extending form due to gravity.

The flexible connecting element 38 is executed in particular elastically. For example, the flexible connecting element 38 has a modulus of elasticity of less than 1 GPa or less than 0.1 GPa. By using an elastic connecting element 38, the force transmission of the exoskeleton 1 to the user can be designed to be more damped and pleasant. With the electric motor 18 switched off, a passive support can be provided in this way, with the connecting element 38 as an elastic drive element. In this way, static postures in forward bending can be supported purely mechanically, specifically in a more energy-efficient manner than with an active electric motor 18.

FIGS. 10 and 11 show schematically the interaction between the drive element 24, the output element 25, the connecting element 38, the second coupling section 16 and the leg rest 14.

The flexible connecting element 38 is wound on the drive pulley and output pulley around at least a part of the respective circumference. Preferably, the connecting element 38 is wound on the drive pulley by at least one revolution or more and/or wound on the output pulley by at most one revolution or less. Exemplarily, the connecting element 38 is fastened to the output pulley, in particular with one end.

The drive element 24 and the output element 25 form a reduction gear, the reduction factor of which is determined by the ratio of the diameters of the drive pulley and output pulley. Exemplarily, the output pulley has a larger diameter than the drive pulley.

In the support mode, the flexible connecting element 38 is tensioned between the drive pulley and output pulley in order to transmit a tensile force from the drive pulley to the output pulley and thus provide the rotational movement coupling, exemplarily only in one direction of rotation. This state is exemplarily shown in FIG. 11. The electric motor 18 sets the drive element 24 into a drive movement, so that the connecting element 38 is wound onto the drive element 24 and unwound from the output element 25, whereby the output element 25 is set into a rotational movement. Thereby, the support force or the relative support pivoting movement between the first support section 4 and the second support section 10 is effected.

Preferably, the torque of the electric motor 18 is closed-loop controlled by the control unit 17 of the exoskeleton 1, for example indirectly via a current closed-loop control. In this way, a smooth start-up can be ensured. In particular if the connecting element 38 is not taut when the motor starts up, a jerk in the connecting element 38 at the moment of tightening can thus be prevented.

Via the flexible connecting element 38, only a force transmission in one direction is possible, in particular a transmission of a tensile force. In the opposite direction, the flexible connecting element 38 is pushed together; no force transmission takes place. Consequently, a freewheel results in the opposite direction to the support force, thus in particular for a relative pivoting movement between the first support section 4 and the second support section 10, in which the bending angle 26 (cf. FIG. 3) is reduced.

In the freewheeling mode, compared to the support mode, an additional connecting element section is unwound from the drive pulley, so that thereby the rotational movement coupling is suspended with respect to the freewheeling angular range and the relative pivoting movement between the first support section 4 and the second support section 10 effected by means of the user force is enabled (in particular in both possible pivoting directions) without the drive element 24 thereby being set into the rotational movement by the output element 25. This state is exemplarily shown in FIG. 10. The output element 25 can here be set into a rotative movement (in particular in each of the two possible directions of rotation) (by a corresponding pivoting movement of the first support section 4), in which the connecting element 38 is wound onto the output element 25, without the connecting element 38 being unwound from the drive element 24, so that the drive element 24 is not itself set into a rotative movement by the rotative movement of the output element 25.

As already mentioned above, the freewheeling mode serves in particular to enable the user to walk comfortably. Here, the user of the exoskeleton 1 requires no support force and the exoskeleton 1 should not hinder during the normal walking movement. The electric motor 18 preferably generates no rotational movement of the drive element 24 and/or no relative support pivoting movement between the first support section 4 and the second support section 10 in the freewheeling mode.

If the second support section 10 and the output element 25 fixedly connected thereto are moved contrary to the direction of rotation which causes a tensile force to arise in the flexible connecting element 38, the user feels no resistance. This is the case e.g. during a step forward.

If the second support section 10 and thereby the output element 25 are moved in the direction of rotation which causes a tensile force to arise in the flexible connecting element 38, the user 2 feels the resistance of the drive element 24 (in particular due to the inertia of the electric motor 18) upon the initial performance of such a movement. The drive element 24 is thereby set into a rotational movement, whereby an unwinding of the flexible connecting element 38 from the drive element 24 takes place. This is the case e.g. when the user moves his concerned leg 13 backwards relative to the upper body 3 during forward walking-i.e., when in the forward movement the other leg is moved forward. Upon repeated actuation of the second support section 10 in this direction, the user 2 feels no further resistance, since the connecting element 38 is already sufficiently unwound and the electric motor 18 is thus no longer rotated.

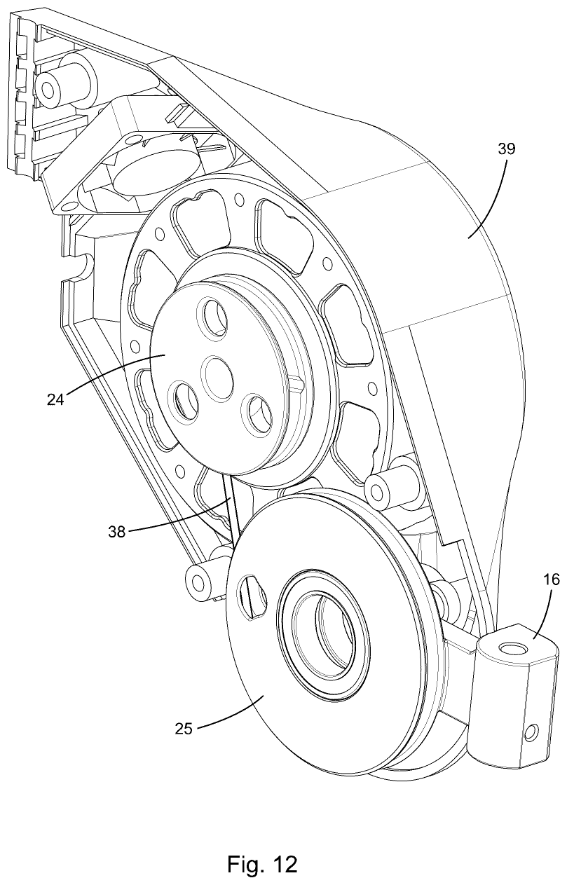

FIG. 12 shows a drive unit 8 with opened drive unit housing 39. The drive element 24 is exemplarily part of the rotor of the electric motor 18 (or represents the rotor of the electric motor 18) or is coupled in a rotationally fixed manner to the rotor of the electric motor 18. The second coupling section 16 is fastened in a rotationally fixed manner to the second output element 32.

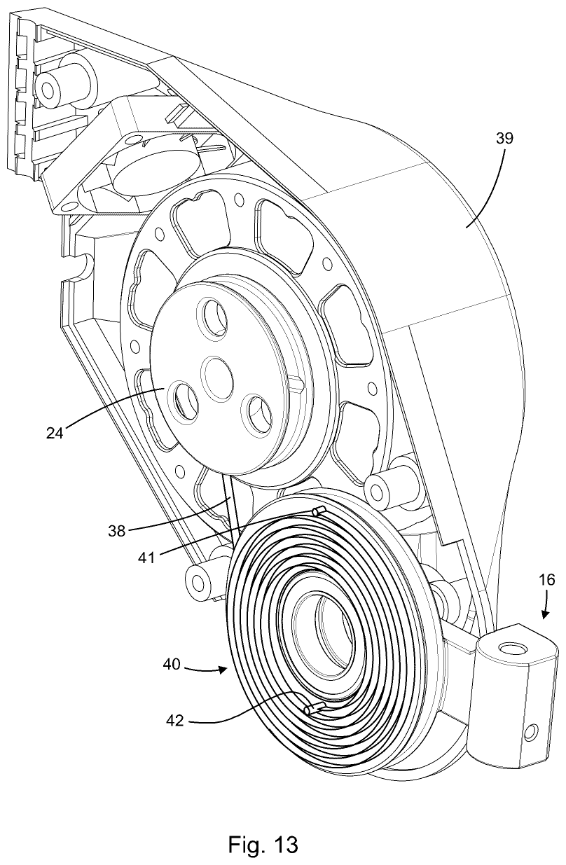

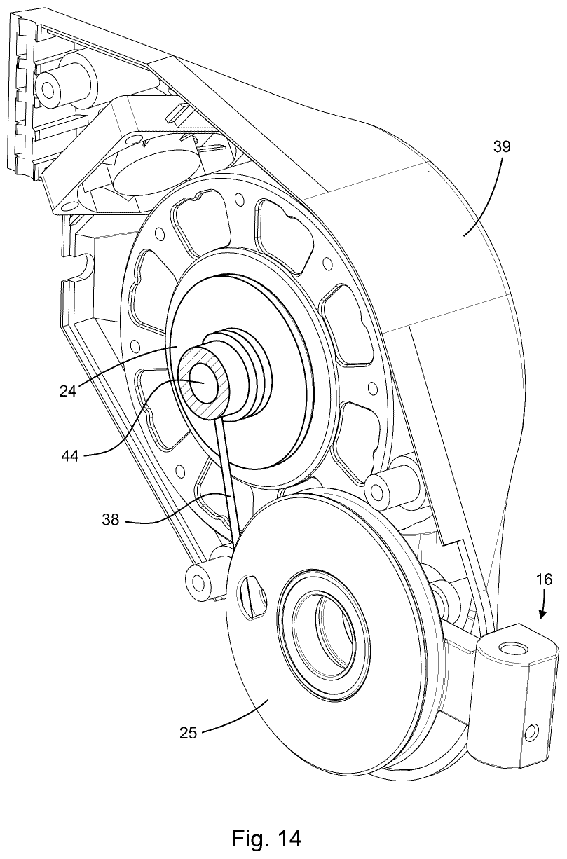

Preferably, the exoskeleton 1 has a spring element 40 which acts on the output pulley in order to effect a pretensioning of the flexible connecting element between the drive pulley and the output pulley in the freewheeling mode. FIG. 13 shows an exemplary design. The spring element 40 is exemplarily designed as a spiral spring and is integrated in particular in the output element 25. The spring element 40 has a first end 41, exemplarily an outer end, to which the output element 25 is fastened. The spring element 40 further has a second end 42, exemplarily an inner end, with which the spring element 40 is fastened to the drive unit housing 39. The spring element 40 acts upon the output element 25 with a spring force which acts in a direction of rotation in which the output element 25 winds up the connecting element 38.

The pretensioning prevents an uncontrolled unwinding of the flexible connecting element 38 from the drive element 24 and from the output element 25. This has the first advantage that an entanglement of the unwound connecting element 38 in the drive unit 8 can be avoided. In addition, as a second advantage, the support force can be built up again more quickly, since less time is needed for winding the unwound connecting element 38 onto the drive element 24. The force of the spring element 40 is selected such that the user feels no or only minimal resistance in the walking movement. The spring element 40 can be designed, for example, as a leaf spring.

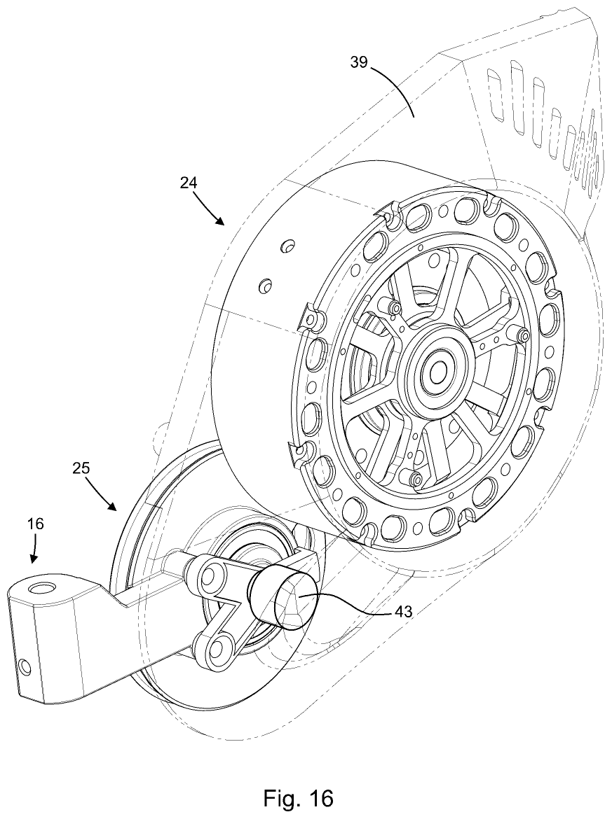

According to a possible design, the drive element 24 has a helical or snail-shaped connecting element receiving structure 44, on which the connecting element 38 is wound and which serves to prevent the connecting element 38 from rubbing against itself during winding onto the drive element 24 and unwinding from the drive element 24. In FIG. 14, the connecting element receiving structure 44 is shown schematically. The connecting element receiving structure 44 is designed in particular as a snail-shaped winch. The connecting element 38 is wound onto the connecting element receiving structure 44 in particular helically. Preferably, the exoskeleton 1 comprises a movement sensor 43, for example a rotation angle sensor, for detecting a rotational movement of the output element 25. An exemplary movement sensor 43 is shown in FIG. 16. The drive device is preferably designed, in the freewheeling mode, to drive the drive element 24 on the basis of the detected rotational movement, such that in response to a detected rotational movement of the output element 25 in an unwinding direction of rotation, in which the connecting element 38 is unwound from the output element 25, the connecting element 38 is wound onto the drive element 24. Expediently, the drive device is designed, in the freewheeling mode, to drive the drive element 24 on the basis of the detected rotational movement, such that in response to a detected rotational movement of the output element 25 in a winding direction of rotation, in which the connecting element 38 is wound up by the output element 25, the connecting element 38 is unwound from the drive element 24.

The drive element 24 is thus driven (on the basis of the detected rotational movement of the output element 25) in particular (by means of the electric motor 18) such that it rotates in the same direction of rotation as the output element 25. In particular, the drive device is designed, in the freewheeling mode, to drive the drive element 24 on the basis of the detected rotational movement such that the connecting element 38 is kept at a pretension by the drive element 24. In this way, an uncontrolled unwinding of the flexible connecting element 38 from the drive element 24 and from the output element 25 can be prevented.

The designs discussed below can be realized in particular in each of the two embodiments discussed above.

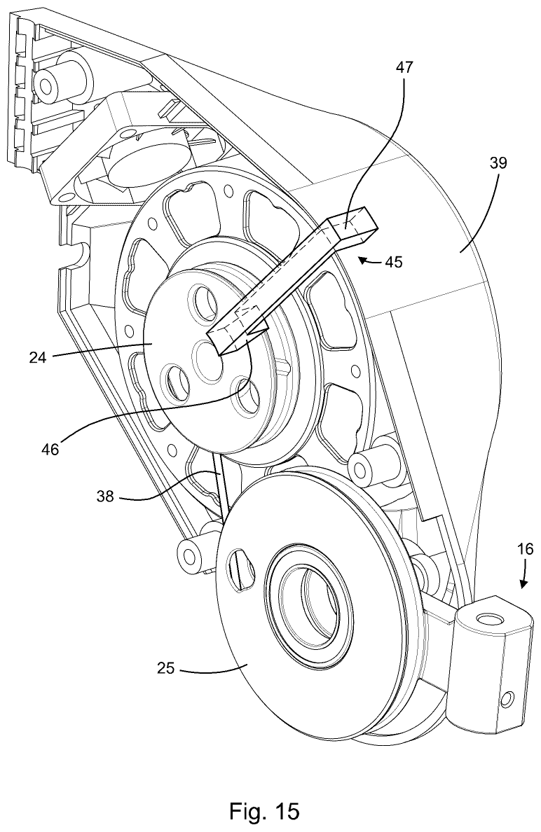

According to a possible design, the exoskeleton comprises a mechanical brake device 45, by means of which the drive element 24 and/or the output element 25 and/or the second output element 32 can be braked and/or completely blocked. FIG. 15 shows an exemplary design of the exoskeleton 1 with such a brake device.

Exemplarily, the brake device 45 has a brake section 46, for example a slope, which can be pressed against the drive element 24 in order to block the drive element 24 so that it can no longer move rotationally (about its own axis of rotation). Alternatively, the brake device can be provided for the output element 25 or the second output element 32. The brake device 45 expediently has an operating section 47 which can be actuated, in particular pressed, by the user in order to put the brake device 45 into a braking state, in which the brake section 46 is pressed against the drive element 24 (or the output element 25 or the second output element 32). Preferably, the brake device 45 latches into the braking state and in particular a further actuation of the operating section 47 is required to end the braking state. For example, a spring is present, by which the brake device 45 snaps back from the braking state upon the further actuation. By means of the brake device 45, in particular the holding work which the electric motor 18 must perform in static forward leaning postures can be reduced.

According to a further design, the brake device 45 can be activated in an electronically controlled manner.

According to a possible design, the drive element 24, the output element 25 and/or the second output element 32 is designed with a non-uniform diameter in order to vary a support force provided with the first support section 4—in particular the tensile force 27—depending on the position of the drive element 24, output element 25 and/or second output element 32. In particular, a profile of the reduction ratio over the range of motion can be realized by using geometries with non-uniform diameters. This can be implemented, for example, with elliptical gear wheels or rope pulleys. The transmission elements—thus the drive element 24, output element 25 and/or second output element 32—could therein be designed such that, for example during a lifting movement, the greatest support force is achieved at the typically greatest achieved upper body forward inclination.

According to a possible design, a transmission (step-up) or a reduction (step-down) is provided in the support mode between the drive element and the output element.

1. An exoskeleton, comprising:
a first support section for supporting a first body part and a second support section for supporting the exoskeleton against a second body part,
a drive device for providing a relative support pivoting movement between the first support section and the second support section,
wherein the exoskeleton has a support mode and a freewheeling mode and the drive device is designed, in the support mode, to provide a drive torque and to convert the drive torque into the relative support pivoting movement by means of a mechanical rotational movement coupling between a drive element and an output element, and in the freewheeling mode to suspend the mechanical rotational movement coupling between the drive element and the output element with respect to a freewheeling angular range, so that within the freewheeling angular range a relative pivoting movement between the first support section and the second support section effected by means of a user force is enabled without the output element thereby setting the drive element into a rotational movement.

2. The exoskeleton according to claim 1, wherein the exoskeleton is a back exoskeleton, the first support section serves to support the upper body and the second support section serves for support against a leg, and the freewheeling angular range is designed such that a user of the back exoskeleton can perform a complete step cycle with at least one leg in the freewheeling mode without the drive element thereby being set into a rotational movement by the output element due to a relative pivoting movement between the first support section and the second support section effected by the step cycle.

3. The exoskeleton according to claim 1, wherein the output element is displaceable into a freewheeling position in order to thereby suspend the rotational movement coupling with respect to the freewheeling angular range, wherein the output element is displaceable into the freewheeling position by a relative pivoting movement between the first support section and the second support section effected by means of a user force.

4. The exoskeleton according to claim 1, wherein the exoskeleton is designed to detect whether an application situation associated with the support mode or the freewheeling mode is present and to control the provision of the drive torque on the basis of this detection.

5. The exoskeleton according to claim 1, wherein the drive element and the output element together form a mechanical clutch which comprises at least one engagement section and at least two end stops, between which a circular arc path is defined, along which the engagement section is movable relative to the end stops, wherein the clutch is placeable into a transmission state, in which the engagement section stands in engagement with the one or the other of the two end stops in order to provide the rotational movement coupling, and is placeable into a freewheeling state, in which the engagement section is spaced apart from both end stops and is movable along the circular arc path in order to suspend the mechanical rotational movement coupling between the drive element and the output element with respect to the freewheeling angular range, wherein the freewheeling angular range is defined by the length of the circular arc path.

6. The exoskeleton according to claim 5, wherein the output element is a first output element and the drive device further comprises a second output element standing in engagement with the first output element and is designed, in the support mode, to provide the support pivoting movement by the drive torque being transmitted by means of the mechanical clutch from the drive element to the first output element and being converted into the support pivoting movement by the engagement of the first output element with the second output element.

7. The exoskeleton according to claim 6, wherein the first output element is a first gear wheel and the second output element is a second gear wheel.

8. The exoskeleton according to claim 7, wherein the second gear wheel has a toothing only along a circular arc, so that the conversion of the drive torque into the support pivoting movement takes place only within the angular range of this circular arc.

9. The exoskeleton according to claim 6, wherein the exoskeleton has a sensor device for detecting a rotational movement of the second output element, and the drive device is designed, in the freewheeling mode, to drive the drive element on the basis of the detected rotational movement such that the engagement section is kept at a distance from the end stops.

10. The exoskeleton according to claim 1, wherein the drive device has a flexible connecting element, and the drive element comprises a drive pulley and the output element comprises an output pulley, wherein the flexible connecting element is wound on the drive pulley and output pulley around at least a part of the respective circumference, is tensioned between the drive pulley and output pulley in the support mode in order to transmit a tensile force from the drive pulley to the output pulley and thus provide the rotational movement coupling, and in the freewheeling mode, compared to the support mode, an additional connecting element section is unwound from the drive pulley, so that thereby the rotational movement coupling is suspended with respect to the freewheeling angular range and the relative pivoting movement between the first support section and the second support section effected by means of the user force is enabled without the drive element thereby being set into the rotational movement by the output element.

11. The exoskeleton according to claim 10, wherein the drive device has a spring element which acts on the output pulley in order to effect a pretensioning of the flexible connecting element between the drive pulley and the output pulley in the freewheeling mode.

12. The exoskeleton according to claim 10, further comprising a movement sensor for detecting a rotational movement of the output element, wherein the drive device is designed, in the freewheeling mode, to drive the drive element on the basis of the detected rotational movement, such that in response to a detected rotational movement of the output element in an unwinding direction of rotation, in which the connecting element is unwound from the output element, the connecting element is wound onto the drive element, and/or in response to a detected rotational movement of the output element in a winding direction of rotation, in which the connecting element is wound up by the output element, the connecting element is unwound from the drive element.

13. The exoskeleton according to claim 12, wherein the drive device is designed, in the freewheeling mode, to drive the drive element on the basis of the detected rotational movement such that the connecting element is kept at a pretension by the drive element.

14. The exoskeleton according to claim 10, wherein the flexible connecting element is elastic.

15. The exoskeleton according to claim 10, wherein the drive element has a helical or snail-shaped connecting element receiving structure, on which the connecting element is wound and which serves to avoid that the connecting element rubs against itself during winding onto the drive element and unwinding from the drive element.

16. The exoskeleton according to claim 1, further comprising a mechanical brake device, by means of which the drive element and/or the output element and/or a second output element can be braked and/or completely blocked.

17. The exoskeleton according to claim 1, wherein the drive element, the output element and/or a second output element is designed with a non-uniform diameter in order to vary a support force provided with the first support section depending on the position of the drive element, output element and/or second output element.

18. The exoskeleton according to claim 1, wherein in the support mode, a step-up ratio or a step-down ratio is given between the drive element and the output element or between the output element and a second output element.

19. The exoskeleton according to claim 1, wherein the exoskeleton is a back exoskeleton for supporting a lifting movement performed with the upper body, the first support section is for supporting an upper body of a user, and the second support section is for supporting the exoskeleton against a leg of the user.

20. A method for operating an exoskeleton according to claim 1, comprising the steps:
operating the exoskeleton in the support mode, in which the drive device provides the drive torque and converts it into the relative support pivoting movement by means of the mechanical rotational movement coupling between the drive element and the output element,
putting the exoskeleton into the freewheeling mode, and
operating the exoskeleton in the freewheeling mode, in which the mechanical rotational movement coupling between the drive element and the output element is suspended with respect to the freewheeling angular range, wherein within the freewheeling angular range the relative pivoting movement between the first support section and the second support section effected by means of the user force is performed without the output element thereby setting the drive element into a rotational movement.
